(19) United States
(12) Patent Application Publication
(10) Pub. No.: US 2009/0254400 A1
(43) Pub. Date: Oct. 8, 2009

(54) SYSTEMS AND METHODS FOR EMPLOYEE COMPENSATION PLANNING

(76) Inventor: Terrance L. Lillie, Emerald Hills, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/417,591

(22) Filed: Apr. 2, 2009

Related U.S. Application Data
(60) Provisional application No. 61/042,223, filed on Apr. 3, 2008.

(51) Int. Cl. G06Q 10/00

(52) U.S. Cl. 705/8

(57) ABSTRACT

A compensation plan budget is validated for each of a plurality of compensation planners within an enterprise. Each of the compensation planners has an individually allocable sub-budget of the overall compensation plan budget. During periods when a compensation planning application used by the compensation planners is otherwise idle, accumulated totals for compensation packages allocated by these compensation planners are determined. These accumulated totals for the compensation packages allocated by the compensation planners as so determined are compared with stored versions of the accumulated totals for the compensation packages. The stored versions of the accumulated totals are those having been computed by the compensation planning application. A determination is made as to whether any discrepancies between the determined ones of the accumulated totals and the stored versions thereof exist; and, in the event of such discrepancies, erroneous ones of the stored versions of the accumulated totals are revised.

### RELATED APPLICATION

This application is a Non-Provisional of, incorporates by reference in its entirety, and hereby claims the priority benefit of U.S. Provisional Patent Application No. 61/042,223, entitled “Systems and Methods for Employee Compensation Planning”, filed 3 Apr. 2008 by the present inventor and assigned to the assignee of the present invention.

### FIELD OF APPLICATION

The present invention relates to platforms configured to facilitate total compensation package planning for workforces that may be made up of large numbers of geographically dispersed employees.

### BACKGROUND

Although there are several existing solutions that are marketed under the guise of compensation planning software or systems, these solutions tend to be very expensive to implement and difficult to configure and maintain. This is perhaps not surprising, inasmuch as compensation planning for a global workforce is a complex problem. The variety and dynamic character of government-mandated and company-imposed rules for employee compensation virtually necessitate complex solutions.

Given the complex nature of the problem, to date most compensation planning providers have developed applications that are specifically configured to the needs of their clients. Such solutions tend to offer limited functionality and, when needs vary from client to client, or when they change from year to year or by geographic region, the clients must return to the providers for software reprogramming, application updates and reconfigurations. This process is both time consuming and expensive.

In general then, this “hard-wired” approach to compensation planning systems is inherently self-limiting because the business either imposes severe restrictions on the client base or the many implementations approach simply will not scale efficiently for the developer. Consequently, what is needed are improved systems and methods for compensation planning.

### SUMMARY

In one embodiment of the invention, a compensation plan budget is validated for each of a plurality of compensation planners within an enterprise. Each of the compensation planners has an individually allocable sub-budget of the overall compensation plan budget. During periods when a compensation planning application used by the compensation planners is otherwise idle, accumulated totals for compensation packages allocated by these compensation planners are determined. These accumulated totals for the compensation packages allocated by the compensation planners as so determined are compared with stored versions of the accumulated totals for the compensation packages. The stored versions of the accumulated totals are those having been computed by the compensation planning application. A determination is made as to whether any discrepancies between the determined ones of the accumulated totals and the stored versions thereof exist; and, in the event of such discrepancies, erroneous ones of the stored versions of the accumulated totals are revised.

### BRIEF DESCRIPTION OF THE DRAWINGS

The present invention is illustrated by way of example, and not limitation, in the figures of the accompanying drawings, in which:

FIG. 1 illustrates an example of a system enabled to validate a compensation plan of an enterprise, consistent with embodiments of the present invention;

FIG. 2 illustrates an example of a software architecture for a compensation planning application configured in accordance with embodiments of the present invention; and

FIG. 3 illustrates a process for validating a budget allocated in a compensation plan of an enterprise, consistent with embodiments of the present invention.

### DESCRIPTION

Described herein are systems, computer readable media, and methods to facilitate total compensation package planning for workforces that may be made up of large numbers of geographically dispersed employees. In one embodiment, the present invention is instantiated as a configurable, computer-based application that supports variability in compensation planning rules and data representation without requiring that the application be reprogrammed. This flexibility permits users of the computer-based application to update or revise methodologies used for compensation planning (e.g., in response to company-based initiatives or government-mandated regulations for particular jurisdictions) as needed.

As will be apparent from the description below, various embodiments of the present invention may be implemented with the aid of computer-implemented processes or methods (a.k.a. programs or routines) that may be rendered in any computer language. As an example, certain modules that comprise one instantiation of the present invention may be written in a compiled language, such as Java™ or the like. Moreover, some portions of this detailed description that follow are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a programmed computer system, or similar electronic computing device, that manipulates and transforms data represented as physical (electronic) quantities within the computer system's registers and memories into other data similarly represented as physical quantities within the computer system memories or registers or other such information storage, transmission or display devices.

Where embodied as computer-readable instructions, the present application may be executed on or by a computer system. In such instances, the application may reside as a computer program stored in a computer readable storage medium, such as, but not limited to, any type of disk including floppy disks, optical disks, CD-ROMs, and magnetic-optical disks, read-only memories (ROMs), random access memories (RAMs), electrically programmable ROMs (EPROMs), electrically erasable programmable ROMs (EEPROMs), flash memories, magnetic or optical cards, or any type of media suitable for storing electronic instructions. The algorithms and processes presented herein are not inherently related to any particular computer or other apparatus.

Importantly, the present compensation planning system also provides for budget validation. During the course of a compensation planning cycle, each time a manager changes an amount allocated to an employee, the associated budgets allocated for that manager are also recalculated. In a typical application instance that involves planning for base pay, bonus and non-cash compensation, a single manager may be associated with over one hundred or more budget calculations. The results of these computations are then “rolled up” so that more senior managers can see the financial impact of the manager's decisions. In an organization with many dozens or even hundreds of managers, this data set could consist of several hundred thousand numeric entries. Of course, it is critical to the financial health of the enterprise (and the affected employees) that these numbers be accurate.

In order to assure that these calculations are correct, the present compensation planning system includes an administrative process that runs during otherwise dormant periods during the compensation planning cycle to perform a “bottoms up” calculation of all manger budgets and compares the results to what exists in the database. This process will catalog and report (and perhaps repair) any anomalies that it discovers in the process.

The individual computations performed by the administrative budget validation process may be based on simple arithmetic, using the projected compensation figures supplied to the system by each manager for each employee and comparing the results of simple additions of these figures to the subject manager's allocated budgets for various compensation components. As each level of manager is validated, summary results from that level can form the input to a next higher level manager's computations and so on until an entire compensation budget for an enterprise is validated. The budget validation process may operate in either of two modes: validate only, which produces a report of the discrepancies that are uncovered; or validate and repair, which updates the manager totals if they are determined to be erroneous. The time required to complete the budget validation process will vary depending on the size of the organization, the number of computations to be performed, etc. Hence, it is advantageous to run the process when the application is otherwise idle.

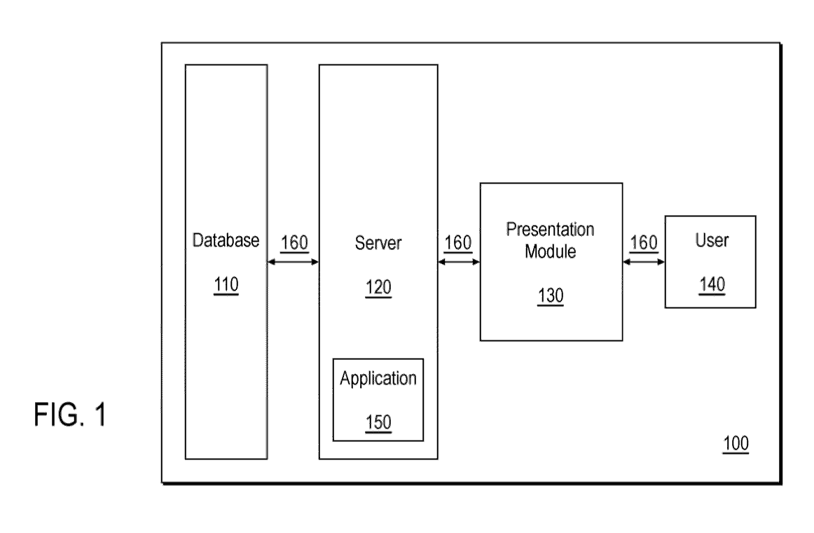

FIG. 1 illustrates an example of a system 100 for implementing a compensation planning software application. System 100 may include a database 110, an application server 120, a presentation module 130, a user 140, an application 150 and communication links 160. Database 110 may include actual data (e.g., employee names, compensation data, etc.) for an enterprise and may be maintained by, for example, the enterprise or another entity at the direction of the enterprise. Database 110 may be resident on, for example, server 120 or an external memory device, such as a disk drive. Server 120 may be any software application server, such as IBM's™ WebSphere Application Server“ ” (WAS), Red Hat's JBoss™ application server, etc. and presentation module 130 may be, for example, a computer system configured with a web browser such as Microsoft's Internet Explorer™. User 140 may be any user of system 100, such as an executive, manager, and/or employee of an enterprise. Application 150 may be, for example, an application for compensation planning and may be resident in, for example, a server, such as server 120. Communication links 160 may be any appropriate means of facilitating communication between the components of system 100, such as wired and/or wireless communication links.

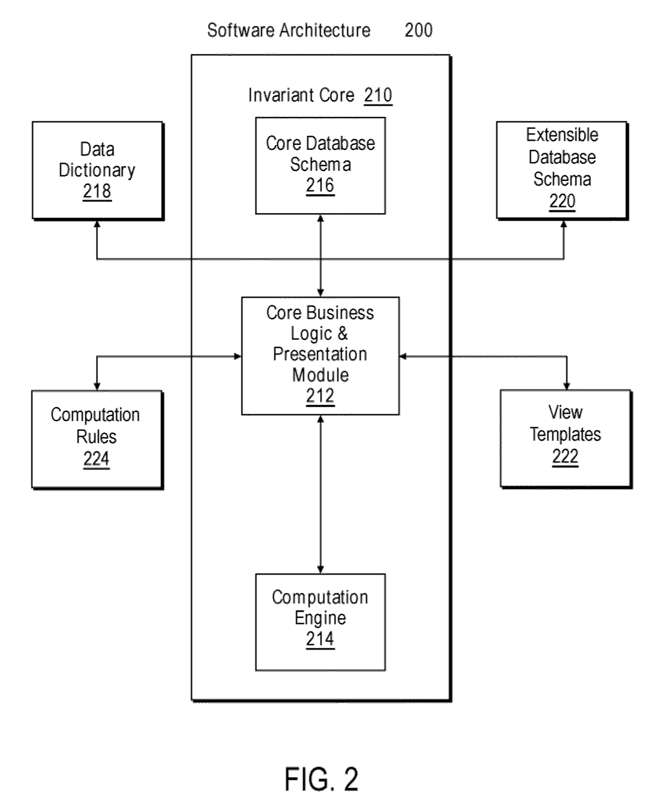

FIG. 2 illustrates an example of a software architecture 200 for an application configured in accordance with an embodiment of the present invention. Application 200 may be installed on server 120 and accessible to user 140 via presentation module 130. As shown, a modularized approach is used so that the overall application is made up of certain modules comprising an invariant core 210 of the application, and other dynamic modules which are highly customizable. The modules that make up the invariant core of the application may include a core business logic and presentation module 212, a computation engine module 214 and/or a core database schema module 216. The dynamic modules of this architecture may include a data dictionary module 218 (which may be memory resident when the application is executing on a computer system such as server 120), an extensible database schema module 220, a view templates module 222, and a computation rule module 224. This modularized approach to software implementations of the present compensation planning system allows for a wide variety of user-specific implementations without the need to reprogram vast libraries of, for example, business rules, presentation formats, and other elements thereof. Not shown in this illustration is a database, such as database 110, that stores the actual data (e.g., employee names, compensation data, etc.) for an enterprise, but those of ordinary skill in the art will appreciate that such a database exists and is made accessible to the application during run time.

In some implementations, the dynamic ones of the different software modules are represented in text-based, extensible markup language (XML) form. In such instances, unique implementations of the software application can then be created by editing a set of XML templates that define, for example:

a. user-specific data elements;

b. application calculations (e.g., validation rules);

c. compensation plan descriptions; and/or

d. user-facing data representations (i.e., view templates).

These XML templates may be configured through an administrative user interface that abstracts the complexity of the configuration details from the user. This allows for a high level of configurability with respect to the rules and data representations governing a particular enterprise's compensation planning process without introducing significant complexities to the actual programming task.

As shown in the illustration, at the heart of the software architecture lies the core business logic and presentation module 212. This module is responsible for manipulating the user data according to a defined rule set for compensation planning. While some of these rules (e.g., those which are applicable to any, or virtually any, enterprise) may be specified as part of the application's invariant core (which encompasses application logic that is common to all instantiations of the application, i.e., those portions of the application which are enterprise agnostic, and/or provides functionality common to all such instantiations and that is used as a basis for performing customizations, e.g., a compensation engine), many such rules will be enterprise-specific and so can be specified as part of the computation rule module 224. That is, the core business logic module 212 may be configured to draw upon enterprise-specified rules described in the computation rules module 224 in order to produce results that comply with that enterprise's policies for compensating its employees. Further, customary, local, regional, national and/or other governmental rules pertaining to a compensation package of an employee of an enterprise can be specified as part of either the extensible compensation rule module 224 or data dictionary 218 and, hence, can be customized for an enterprise's needs.

The core business logic and presentation module 212 may include presentation rules applicable to or desirable for any (or virtually any) enterprise. These presentation rules may define how data is formatted and/or presented to users for use in the compensation planning process. The presentation rules may make use of detailed view templates to prepare a planning page to be displayed to a user.

The view template module is configured to process the view templates to facilitate formatting and display of data defined by the data dictionary module. For example, the view template module may read the view templates, retrieve associated data described by the data dictionary module and produces display objects for the presentation module.

View templates may be specified by a configurable view template module 222. Such view templates may be organized by business unit, country, page identifier, porlet identifier, view identifier or other criteria. Default view templates may be made available in the event a specific view that does not match any of these criteria is required. In some embodiments, this scheme is extensible so that if there is a need for different views for job families, e.g., executive managers versus salaried employee managers that need can be accommodated. Templates that are differentiated by any indicator field in the demographic input file (usually generated by the end user's enterprise resource planning system) can be created.

The core business logic and presentation module 212 may make use of computation engine module 214 to perform calculations specified by computation rules for compensation planning. As indicated above, the actual compensation rules may be stored in the data dictionary 218. By specifying the computation rules separate from the computation engine itself, the present system allows for a high degree of customization on a per-user (i.e., per-enterprise) basis.

The compensation rules may be derived from national, regional or local statutory or other governmental requirements, as well as other sources (for example, recognized “best practices” within a given industry may be expressed as compensation rules within the present compensation planning system). As such, the rules are subject to and can be changed over time (for example, as statutory schemes are revised or amended, as an enterprise adopts new policies or procedures, or as industry best practices evolve to accommodate new circumstances or business organizations). The rules may be expressed as equations (to be evaluated by the computation engine) and stored in the data dictionary, for example as strings that define a series of arithmetic and/or conditional operations. Such strings may be stored within appropriate fields of tables that comprise the data structure of the data dictionary.

The computation engine module 214 may include algorithms to compute various results, as directed by the various computation rules. During a planning cycle, as a user makes modifications to some variables, the computation engine module 214 may automatically make modifications to other variables affected by the user inputs and those changes may be reflected via one or more views provided by presentation module 130. Generally, such computations are run against data stored in the database 110 and the data dictionary 218 is used to assign variable names to each field and to identify a location in the database where the corresponding data element can be found.

Of course, the core business logic and presentation module 212 generally operates on user-supplied data that arrives at the module in an expected format. The rules defining that format are specified in the core database schema 216 and/or the extensible database schema 220. More specifically, these schemas collectively define the various tables which store the user data, fields in each of these tables, and relationships between those fields and tables. User data may be stored in and/or retrieved from a database, such as database 110.

In some instances, data dictionary 218 may be an XML file that contains mappings between variable names, database fields and calculation equations. However, defining the data dictionary in such a fashion tends to be somewhat unwieldy. Accordingly, it may be preferable to instead construct the data dictionary using a data dictionary editor.

A further important aspect of the present invention is a calculation index, that is, a table or other data structure defining an order in which computations are to be performed when computing affected variables for a compensation plan when a cross-calculation in initiated by any update (e.g., an update initiated by a user). This calculation index may be built as a companion to the data dictionary as new data dictionary variables and equations are entered. At run time, the calculation index is consulted by the computation engine, which invokes the referenced equations in the order described in the calculation index as updates are received.

Having thus examined the overall architecture of a software application that provides compensation planning facilities in accordance with an embodiment of the invention, we turn to various aspects of that application in greater detail. A compensation plan may include a plurality of hierarchal tiers, each tier corresponding to a different level of management within the enterprise, a different group within the enterprise, or some other division within the enterprise. Herein, the example of management layers will be used, but this should not be read as strictly limited to management layers, as other divisions within an enterprise may be substituted for such or used in conjunction with such management layers. Each tier will generally include or be associated with data associated with that portion of the enterprise which it represents, and often higher layer tiers will reflect generalizations or summaries of such data regarding lower layer tiers. This data may be stored in database 110 and formatted according to schemas defined by the cored database schema or the extensible database schema.

The tiers of a compensation plan may be arranged such that, for example, a base or first tier is the broadest such tier in a hierarchy of tiers forming a compensation plan, containing or associated with data at a finest level of granularity. Subsequent tiers within the hierarchy may then be successively narrower than each preceding tier and include or be associated with data summarized from the preceding tier(s). For example, a first tier of a compensation plan may represent a lowest level of management within an enterprise, while a second tier may represent a higher level of management, and so on such that the highest tier of the compensation plan represents the highest level of management within the enterprise. A sub-budget may be allocated to each tier of the compensation plan, allowing associated managers to make compensation allocations and adjustments appropriate to the groups which those managers oversee.

During a compensation planning cycle, it is often the case that managers who oversee one or more employees of the enterprise are allocated a budget for compensation increases (both cash compensation and non-cash compensation) and the individual manages must determine how to allocate these budgets among their team members (e.g., in the form of raises, performance incentives, and the like). The present compensation planning application provides managers with a view that informs the manager of an allocable compensation budget (which may include cash and non-cash components) and which also accounts for any allocations already made by the manager to his/her direct reports as part of the compensation planning cycle (e.g., amounts already allocated to individual employees, groups, etc.). In addition, if the manager is one that oversees other managers, then the manager may be provided with a summary of allocations made by those lower level managers as part of a roll up budget view. The ability to view both direct report budgets (so-called team budgets) and roll up budgets means that the manager can have an overall appreciation for how his/her compensation budget is presently allocated as well as remaining amounts yet to be allocated, all at appropriate levels of granularity for the manager's position within the enterprise.

To provide this visibility in team and roll up budgets, individual tiers of a compensation plan may include data from across the enterprise or may be limited to, for example, data associated with one or more categories or segments of the enterprise. Exemplary categories include geographical regions, a projects, divisions of the enterprise, job functions, degrees of responsibility or management level within the enterprise, degrees of management capacity of the enterprise, and/or compensation type.

At the outset of a planning cycle, the direct, or team, and roll up budgets are calculated in accordance with the compensation planning rules specified in the data dictionary. Collectively, these budgets define a compensation plan for the enterprise. As indicated, the compensation plan may include a number of hierarchal tiers and sub-budgets may be allocated to each tier. During the planning cycle, managers at various levels of the hierarchy make adjustments to their allocated sub-budgets as they award raises or make other compensation changes among their team members or enterprise divisions. As each budget entry is modified, an update event is generated for the compensation planning application and that update event and the modified variable are passed to the calculation engine to determine the effect of the modification. For example, the compensation engine will compute new compensation plan values according to its calculation index table. At the end of the cross calculation sequence, the allocated and available values for the direct and roll up budgets are recomputed and propagated up through the hierarchy of the compensation plan. In this way, the allocations made by mangers at various levels of the enterprise are immediately reflected throughout the entire compensation plan.

As should be apparent, each modification made by a manager affects the entire compensation plan and may involve many individual computations. In order to ensure that all such computations are performed correctly, and in a correct sequence, the present invention provides for validating these computations when the compensation planning application is otherwise idle. Such validation may include, for example, verifying that an individual sub-budget is complete, verifying that planned and/or actual expenditures associated with a tier of the compensation plan are aligned with allocated funds, verifying the accuracy of calculations within a sub-budget, verifying that calculations related to other sub-budgets and/or higher layer budgets are accurate and/or complete, etc. The validation operations may be performed by the computation engine using the compensation plan rules specified in the data dictionary.

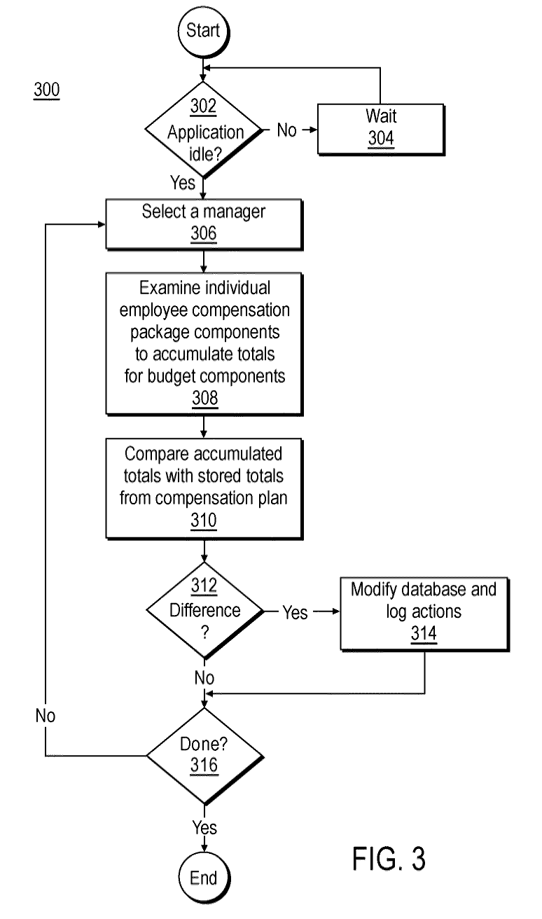

An example of a validation process 300 is illustrated in FIG. 3. At 302, the validation process (which runs as a background process) determines whether or not the compensation planning application idle. If not, the process waits (304). When the application is otherwise idle, the validation process proceeds and selects a sub-budget or budget associated with a manager for validation 306. The validation processes will traverse the entire hierarchy of the compensation plan and may include stored indices to determine where to commence with a next manager for review (e.g., based on where previous validation processes finished or where modifications to a compensation plan were last made, etc.).

For each sub-budget or manager under review, the validation process examinees the individual components of each employee's compensation reflected in the sub-budget 308. This may include both cash and non-cash components of the employee's compensation package and may include base pay, bonuses, long term incentives, etc. As each employee's compensation package is examined, the validation process accumulates totals for the allocated and available (i.e. as yet unallocated) amounts for the subject manager's direct and roll up budgets.

The validation process then compares, 310, the accumulated results with the totals for these direct and roll up budgets stored by the compensation plan application. That is, the validation process checks to see whether there is a difference between the actual allocated and available amounts left in these budgets (as determined from a direct review of each employee's compensation package) and the amounts reflected in the compensation planning application 312. Differences can result, for example, if compensation rules have not been executed in the right order or other errors have occurred during the compensation planning process.

If discrepancies are found, then the budget totals for the compensation planning application may be updated and these activities logged for later user review 314. Thereafter, of if no discrepancies are noted, the validation process checks to see whether all budgets for all managers have been reviewed 316. If not, the process repeats for another manager, until all such manager budgets have been reviewed and the process ends.

Thus, a platform configured to facilitate total compensation package planning for workforces that may be made up of large numbers of geographically dispersed employees has been described.

What is claimed is:

1. A method for validating a compensation plan budget, comprising:
for each of a plurality of compensation planners within an enterprise, said compensation planners each having individually allocable sub-budgets of the compensation plan budget, determining, during periods when a compensation planning application used by the compensation planners is otherwise idle, accumulated totals for compensation packages allocated by said compensation planners;
comparing the accumulated totals for the compensation packages allocated by the compensation planners as so determined with stored versions of the accumulated totals for the compensation packages, said stored versions of the accumulated totals having been computed by the compensation planning application, and determining whether discrepancies between the determined ones of the accumulated totals and the stored versions thereof exist; and
in the event of said discrepancies, revising erroneous ones of the stored versions of the accumulated totals and logging the making of such revisions.

2. The method of claim 1, wherein the accumulated totals are determined for direct budgets and roll up budgets for each of the compensation planners.

3. The method of claim 1, wherein the individually allocable sub-budgets are arranged hierarchically with direct budgets of lower levels of the hierarchy being reflected in roll up budgets of higher levels of the hierarchy.
